(19) United States
(12) Patent Application Publication
(10) Pub. No.: US 2007/0068390 A1
(43) Pub. Date: Mar. 29, 2007

(54) Filter structure of an industrial dust-collector

(76) Inventor: Kuo-Chin Cho, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/230,663

(22) Filed: Sep. 21, 2005

(51) Int. Cl. B01D 50/00

(52) U.S. Cl. 96/406

(57) ABSTRACT

A filter structure is provided in the liquid-collecting tank of an industrial dust-collector, and a floating ball and an air-exhausting exit are provided in the filter structure. A soft rubbery cushion ring is provided to sleeve on the elongated portion at the bottom of the screwing section of the filter structure, so as to moderate the impact force of the floating ball when the floating ball is sucked to fully seal up the cushion ring.

### BACKGROUND OF THE INVENTION

1. Field of the Invention

The present invention relates to a filter structure of an industrial dust-collector with innovatory features, and more particularly to a filter structure which is provided with a soft rubbery cushion ring being sleeved on the elongated portion at the bottom of the screwing section of the air-exhausting exit. When the floating ball is forcefully against the cushion ring, the cushion ring can moderate the impact force of the floating ball and force the top portion of the floating ball to be sucked to fully seal up the cushion ring, so as to effectively prevent liquid or oil gas from entering the air-exhausting exit and to prolong the service life of the industrial dust-collector.

2. Brief Description of the Prior Art

The inventor of the present invention had invented a filter structure of an industrial dust-collector, filed at the U.S. Patent & Trademark office on 2 Feb., 2005 and given a Ser. No. 11/047, 648, referring to FIGS. 1 and 2. An air-tight non-mesh section 123 is provided at the upper end of the filter structure 12, the inner diameter of the airtight non-mesh section 123 is almost the same as that of the floating ball 121, and a meshed section 124 is provided at the lower end of the filter structure 12. While being operated, the liquid will flow through the meshed section 124 of the filter structure 12 to force the floating ball 121 to ascend to effectively prevent the liquid or oil gas from entering the air-exhausting exit 122.

However, while being operated, the floating ball 121 of the above-mentioned filter structure ascends to seal up the air-exhausting exit 122 to prevent the liquid from entering the air-exhausting exit 122, and a metal screwing section 125 is provided at the head portion of the filter structure 12. Because the floating ball 121 and the metal screwing section 125 are both made of hard material, the floating ball 121 can not fully seal up the air-exhausting exit 122, so as to influence the service-life of the dust-collector.

### SUMMARY OF THE INVENTION

Therefore, the objective of the present invention is to provide a filter structure of an industrial dust-collector that can substantially obviate the drawback of the related filter structure of an industrial dust-collector.

An objective of the present invention is to provide a filter structure of an industrial dust-collector which is provided with a soft rubbery cushion ring to moderate the impact force of the floating ball and force the floating ball to be sucked to fully seal up the cushion ring, so as to effectively prevent liquid or oil gas from entering the air-exhausting exit and to prolong the service life of the industrial dust-collector.

Accordingly, a filter structure is provided in the liquid-collecting tank of an industrial dust-collector, and a floating ball and an air-exhausting exit are provided in the filter structure. A soft rubbery cushion ring is provided to sleeve on the elongated portion at the bottom of the screwing section of the filter structure, so as to moderate the impact force of the floating ball when the floating ball is sucked to fully seal up the cushion ring.

### BRIEF DESCRIPTION OF THE DRAWINGS

Other features and advantages of the present invention will become apparent in the following detailed description of the preferred embodiments with reference to the accompanying drawings, in which

FIG. 1 is a sectional view of the related industrial dust-collector in assembled configuration;

FIG. 2 is a schematic sectional view of the related filter of an industrial dust-collector in assembled configuration;

FIG. 3 is an exploded perspective view of the cushion ring and screwing section of the filter in accordance with the present invention;

FIG. 4 is a sectional view of the cushion ring and screwing section of the filter in assembled configuration in accordance with the present invention;

FIG. 5 is an exploded perspective view of another embodiment of the cushion ring and screwing section of the filter structure in accordance with the present invention;

FIG. 6 is a sectional view of another embodiment of the cushion ring and screwing section of the filter structure in assembled configuration in accordance with the present invention;

FIG. 7 is a schematic sectional view of the filter structure in accordance with the present invention being provided in an industrial dust-collector;

FIG. 8 is a schematic view of the floating ball of the filter structure ascending to be sucked to seal up the air-exhausting exit in accordance with the present invention; and,

FIG. 9 is a partial enlarged view taken from FIG. 8.

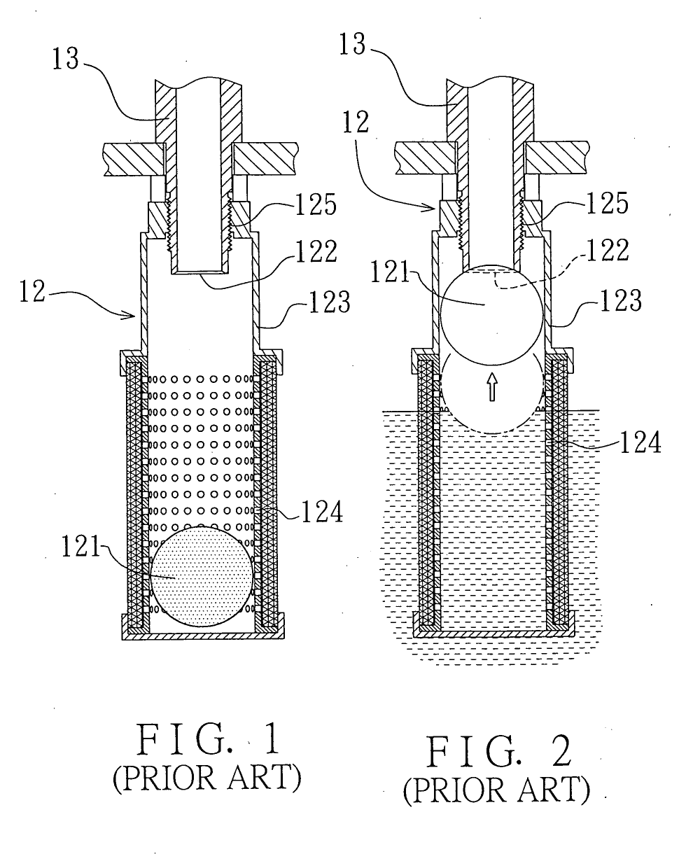

### DETAILED DESCRIPTION OF THE PREFERRED EMBODIMENTS

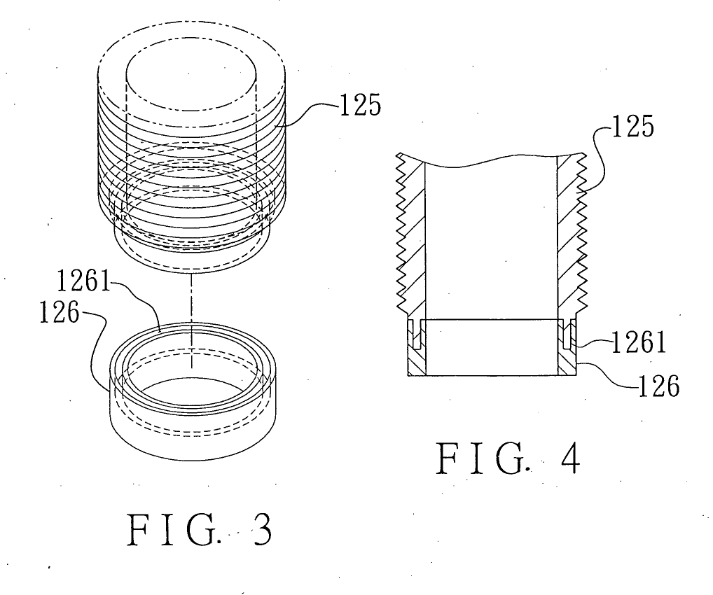

An embodiment of the filter structure 12 in the present invention is provided in the liquid-collecting tank 11 of the main body 1 of an industrial dust-collector, and a floating ball 121 and an air-exhausting exit 122 are provided in the filter structure 12. A soft rubbery cushion ring 126 is provided to sleeve on the elongated portion 1251 at the bottom of the screwing section 125 in the head portion of the filter structure 12, the screwing section 125 is provided to be screwed to the air-exhausting pipe 13, referring to FIG. 3.

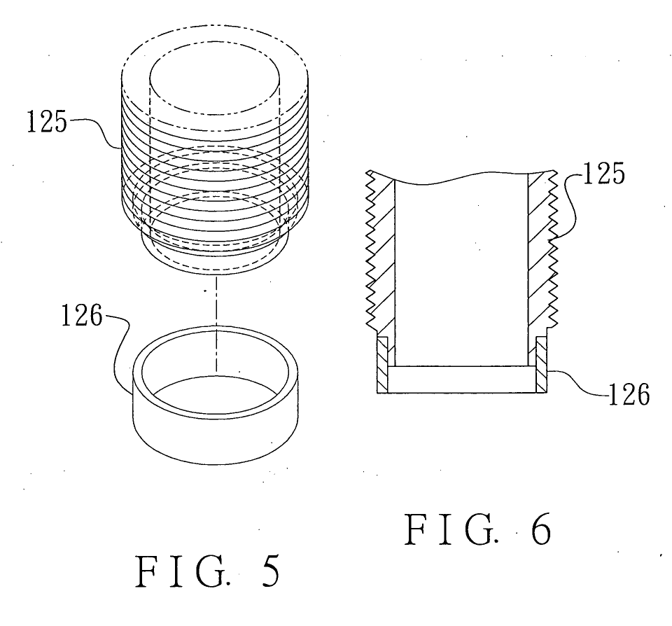

The soft rubbery cushion ring 126, preferably made of silicone or rubber, may be provided with an annular groove 1261 for the elongated portion 1251 at the bottom of the screwing section 125 of the filter structure 12 to be sleeved in, as shown in FIG. 4. Alternatively, the bore of the cushion ring 126 is directly sleeved on the outer surface of the elongated portion 1251 at the bottom of the screwing section 125, as shown in FIGS. 5 and 6.

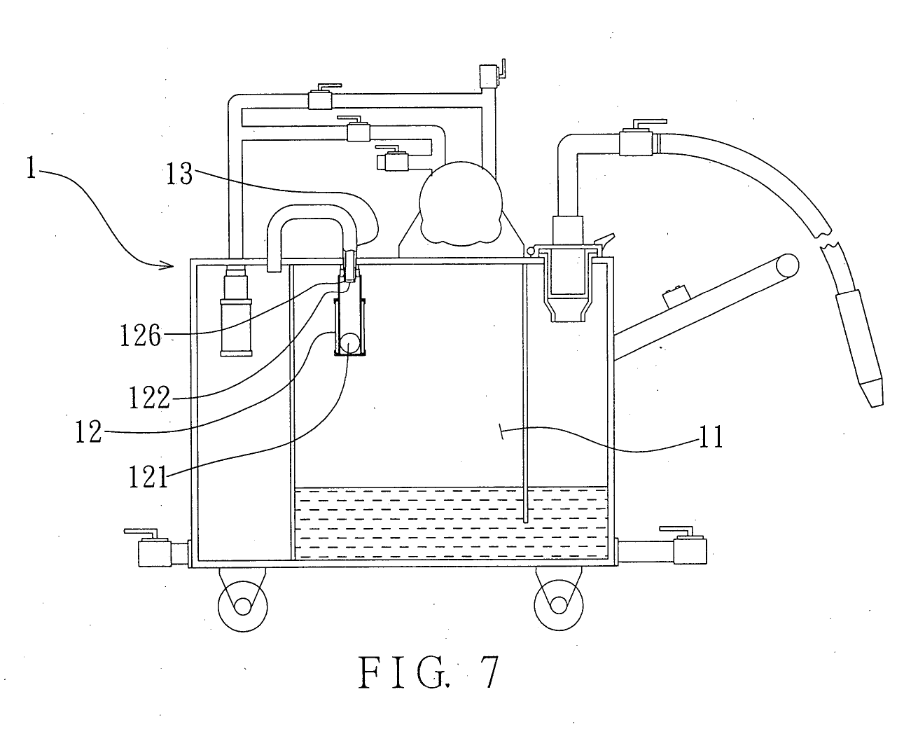

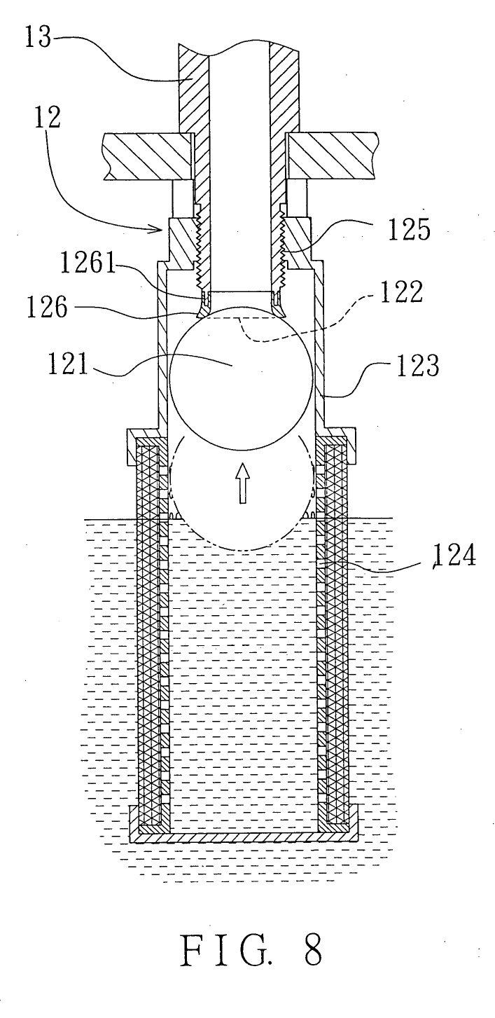

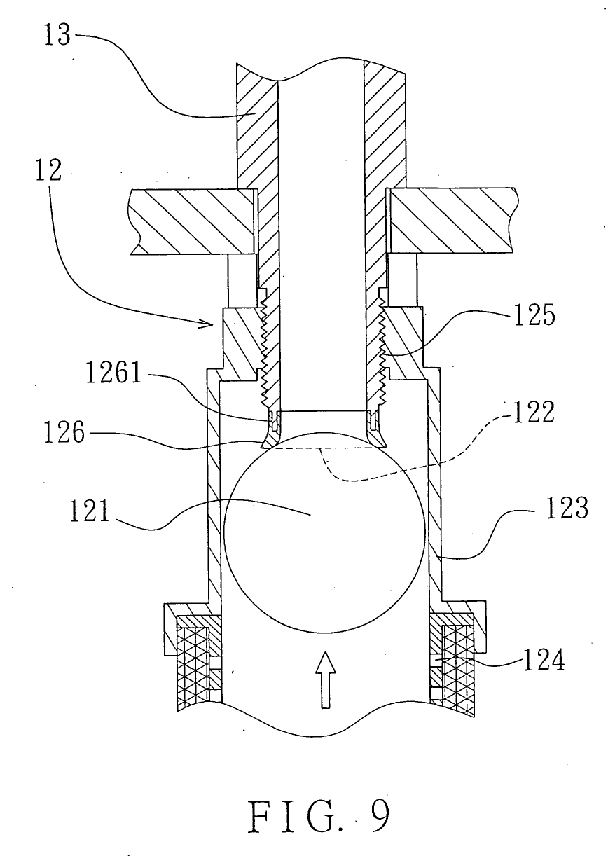

While being operated, referring to FIG. 7, when more and more liquid (industrial waste oil or chemical water) being sucked in the oil-collecting tank 11, the liquid flows through the meshed section 124 of the filter structure 12 to force the floating ball 121 to ascend to approach the airtight non-mesh section 123 of the filter structure 12, and the oil gas is blocked by the surface of the floating ball 121. The floating ball 121 will be sucked by the strong suction of the air-exhausting exit 122 to separate from the liquid, and, at the same time, to be forcefully against the cushion ring 126. The cushion ring 126 can moderate the impact force of the floating ball 121 and force the top portion of the floating ball 121 to be sucked to fully prevent the liquid or oil gas from entering the air-exhausting exit 122, so as to prolong the service life of the industrial dust-collector.

While the preferred embodiments of the invention have been described above, it will be recognized and understood that various modifications may be made therein, and the appended claims are intended to cover all such modifications which may fall within the spirit and scope of the invention.

What is claimed is:

1. A filter structure being provided in the liquid-collecting tank of the main body of an industrial dust-collector comprising:
a soft rubbery cushion ring being provided to sleeve on an elongated portion at the bottom of the screwing section in the head portion of said filter structure.

2. The filter structure of an industrial dust-collector as recited in claim 1, wherein said cushion ring is made of silicone.

3. The filter structure of an industrial dust-collector as recited in claim 1, wherein said cushion ring is made of rubber.

4. The filter structure of an industrial dust-collector as recited in claim 1, wherein said cushion ring is provided an annular groove to sleeve on said elongated portion at the bottom of the screwing section in the head portion of said filter structure.

5. The filter structure of an industrial dust-collector as recited in claim 1, wherein the bore of said cushion ring is directly sleeved on the outer surface of said elongated portion at the bottom of the screwing section in the head portion of said filter structure.
